(19) United States
(12) Patent Application Publication
(10) Pub. No.: US 2009/0026959 A1
(43) Pub. Date: Jan. 29, 2009

(54) Non-contact light emitting display for vehicle

(75) Inventors: Jung Tsung Lin, Taipei County (TW); Ching Chang Weng, Taipei City (TW)

Correspondence Address: BACON & THOMAS, PLLC, 625 SLATERS LANE, FOURTH FLOOR, ALEXANDRIA, VA, 22314-1176, US

(73) Assignees: Jung Tsung Lin, Taipei County (TW); G-Spring Technology Corp., Taipei City (TW)

(21) Appl. No.: 12/219,712

(22) Filed: Jul. 28, 2008

(30) Foreign Application Priority Data
Jul. 27, 2007 (CN) 200710142807.9

(51) Int. Cl. B60Q 1/24

(52) U.S. Cl. 315/77

(57) ABSTRACT

A non-contact light emitting display for a vehicle is disclosed as having at least: a light emitting unit, a first induction coil to supply electric power for the light emitting unit; the first induction coil generates electric power by non-contact induction with an inductor of the vehicle for executing one way or two way signal transmission. Thereby, the non-contact light emitting display can save the provision of exposed electric conductors or conducting pins, it can obtain electric power from the vehicle to execute one way or two way signal transmission, or can be used on an aeronautic, a space or a sea vehicle for illumination with the effect of water proofness and dust proofness.

### BACKGROUND OF THE INVENTION

1. Field of the invention

The present invention relates to a technique of non-contact light emitting display, and especially to a non-contact light emitting display used for a vehicle such as a car, a ship, a flying vehicle, a vehicle without a man and a vehicle for exploring etc., it can be removed by pulling off the vehicle individually when being necessary.

2. Description of the prior art

In order to do illumination, warning and bulletining, a normal vehicle such as a car, a ship, a flying vehicle, a vehicle without a man and a vehicle for exploring etc. is provided interiorly or exteriorly thereof with a plurality of related light emitting displays such as directional signal lamps on the outer surface of a car, an interior reading lamp of a car or a plug-type lamp inserted in an electric socket for cigarette igniting in a car.

These light emitting displays all will need to be provided with related electric conductors or conducting pins to make electric connection with vehicles, in order that light emitting displays can obtain electric power required for operation, or for executing one way or two way signal transmission between the light emitting displays and their vehicles, to thereby help controlling related operations or examination and testing. For instance: a vehicle provides signal for a directional signal lamp for executing control of flashing, or when the directional signal lamp is burned, an examination and testing signal is sent to the vehicle, then the vehicle send accelerating flashing signals to all the other directional signal lamps.

However, when a light emitting display makes electric connection with a vehicle with related electric conductors or conducting pins, it makes electric conducting in a contact mode, such electric conducting in a contact mode at least has the following problems for example:
1. When the light emitting display is to be installed on the vehicle, it involves in a problem of connecting electric conductors or conducting pins, of the space for receiving and of planning of path for conductors.
2. By the existence of the electric conductors, there always are problems of uneasiness of water proofing and dust proofing for the light emitting display, the vehicle and the joints for the electric conductors, once a related water proofing or dust proofing structural part (such as water proof glue or water proof gasket etc.) is ageing, the light emitting display or the vehicle will have the problem of humidity, water penetrating or dust invading etc.
3. When the light emitting display is separated from the vehicle, it is unable to get electric power it needs, and it is unable to be used alone.

In view of these, the inventor of the present invention studied the light emitting display and developed a brand new one that eliminated the provision of electric conductors or conducting pins in using it on a vehicle.

### SUMMARY OF THE INVENTION

The non-contact light emitting display for a vehicle of the present invention is characterized in using the measures of wireless induction on the non-contact light emitting display for a vehicle to obtain the electric power in need. For example, wireless radio frequency is used to make induction of the non-contact light emitting display with the vehicle to obtain electric power, and to effect one way or two way signal transmission between the light emitting displays and their vehicles, to thereby help emitting and receiving of signals including related safety detecting signals and control signals.

The non-contact light emitting display for a vehicle of the present invention at least comprises: a light emitting unit, a first induction coil to supply electric power for the light emitting unit; the first induction coil generates electric power by non-contact induction with an inductor of the vehicle, for instance: the inductor can be provided therein with a second induction coil to generate a magnetic field or a wireless radio frequency inductive magnetic field, in order to make the corresponding first induction coil generate electric power.

For the purpose that electric power can be obtained by means of wireless radio frequency induction when the non-contact light emitting display enters the effective induction scope of the inductor, the non-contact light emitting display can further be provided at least with a first resonant circuit, the inductor can further be provided with a second resonant circuit, a driving amplifying electric circuit and an oscillating circuit, in order to render the non-contact light emitting display to obtain electric power by means of wireless radio frequency induction.

Secondly, for the purpose of enduing the non-contact light emitting display with an effect of independent turning on/off, the non-contact light emitting display can further be provided with an electric source circuit, a switch and a first control circuit to help performing of turning on/off action of the non-contact light emitting display.

And more, for the purpose of making the non-contact light emitting display provide signals such as related safety detecting signals and control signals for the vehicle, the non-contact light emitting display can further be provided therein with a modulating circuit, and the inductor is provided therein with a second signal processor, a second control circuit and a feedback circuit to help performing signal transmission of the non-contact light emitting display to the vehicle.

An more, for the purpose of making the vehicle provide signals such as related safety detecting signals and control signals for the non-contact light emitting display, the non-contact light emitting display can further be provided therein with a first signal processor, and the inductor is provided therein with a wave carrier circuit, to help performing signal transmission of the vehicle to the non-contact light emitting display.

Besides, for the purpose of making the non-contact light emitting display to keep electric power required for operation when it moves away from the effective induction range of the inductor, the display can further be provided therein with a charging circuit and a charging battery, so that the non-contact light emitting display can operate independently when it moves away from the vehicle. For example: when the vehicle is a car, the non-contact light emitting display can be in the form of a movable illuminating lamp, while the vehicle is provided thereon with a fixing seat for insertion connecting an electric source (an electric socket for cigarette igniting) in the car, the fixing seat is provided therein with an inductor; when the non-contact light emitting display is fixed in the fixing seat, it can be conducted by the inductor to get electric power for illuminating interiorly of the car (for reading for instance), and when the non-contact light emitting display is removed from the fixing seat, it can be used as a flashlight.

The present invention at least has the following advantages in comparison with the conventional technique:
1. It is not necessary to provide electric conductors or conducting pins between the non-contact light emitting display and the vehicle, thereby the non-contact light emitting display can be more easily installed on or detached from the vehicle.
2. When the non-contact light emitting display is to be installed on the vehicle, it will not be involved in the problem of connection of electric conductors or conducting pins, neither has a problem of space for receiving and of planning of path for conductors.
3. By the fact that it is not necessary to provide electric conductors or conducting pins between the non-contact light emitting display and the vehicle, perfect measures of water proofing and dust-proof sealing can be performed for the non-contact light emitting display, even a completely sealing structure with high water sealing power can be available in use.
4. When the light emitting display is separated from the vehicle, a charging battery can be used to provide the electric power in need to allow independent operation of the light emitting display.
5. The one way or two way signal transmission can be performed between the light emitting display and the vehicle, to thereby help transmission of related safety detecting signals and control signals.

The present invention will be apparent in its mode of operation after reading the detailed description of the preferred embodiment thereof in reference to the accompanying drawings.

### BRIEF DESCRIPTION OF THE DRAWINGS

FIG. 1 is a perspective schematic view showing a practice example of the present invention;

FIG. 2 is a block diagram showing a first embodiment of the present invention;

FIG. 3 is a block diagram showing a second embodiment of the present invention;

FIG. 4 is a block diagram showing a third embodiment of the present invention;

FIG. 5 is a block diagram showing a fourth embodiment of the present invention;

FIG. 6 is a circuit diagram showing the allocation of electric circuit of the fourth embodiment of the present invention;

FIG. 7 is a perspective schematic view showing another practice example of the present invention;

FIG. 8 is a perspective schematic view showing one more practice example of the present invention;

FIG. 9 is a perspective schematic view showing a non-contact light emitting display of the present invention is made as a flashlight.

### DETAILED DESCRIPTION OF THE PREFERRED EMBODIMENT

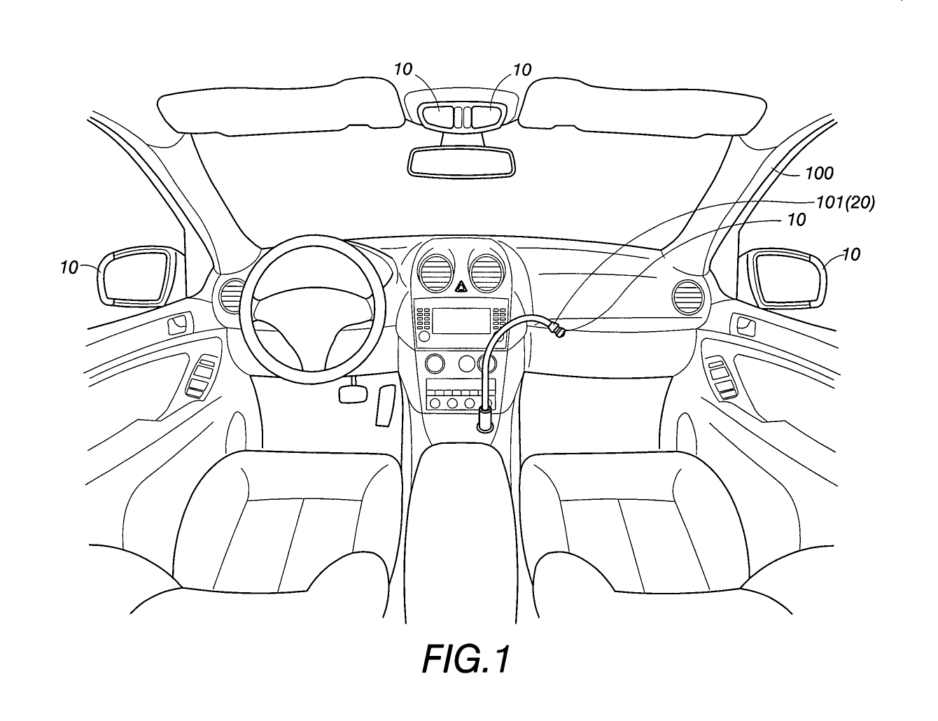

Referring firstly to FIG. 1 which is a perspective schematic view showing a practice example of the present invention, in the drawing, a vehicle 100 is disclosed as a general car for explanation, when in practicing, the vehicle 100 can be a car, a ship, a flying vehicle, a vehicle without a man and a vehicle for exploring etc.; the non-contact light emitting display 10 of the present invention can be provided inside or outside of the vehicle 100, in practicing for instance, it can be a directional signal lamp for a car, a warning lamp, a built-in reading lamp of a car, a reading lamp electrically supplied by a power source of a car, or a warning lamp on a side door of a car etc.

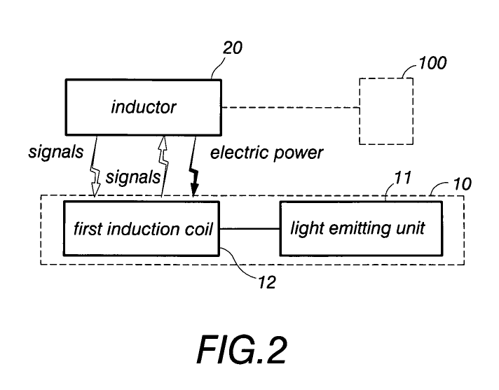

FIG. 2 is a block diagram showing a first embodiment of the present invention, in the drawing, the first embodiment is disclosed to have a light emitting unit 11 and a first induction coil 12, the first induction coil 12 supplies electric power for the light emitting unit 11, and the first induction coil 12 is induced by an inductor 20 of the vehicle 100 to generate electric power.

When the non-contact light emitting display 10 enters the effective induction scope of the inductor 20, the non-contact light emitting display 10 can be induced by the inductor 20 to obtain the electric power in a non-contact induction mode. For example, by using wireless radio frequency, to make induction of the non-contact light emitting display 10 with the vehicle 100 to obtain electric power, and to effect one way or two way signal transmission between the light emitting display 10 and the vehicle 100 by using wireless radio frequency, to thereby help emitting and receiving of signals including related safety detecting signals and control signals etc.

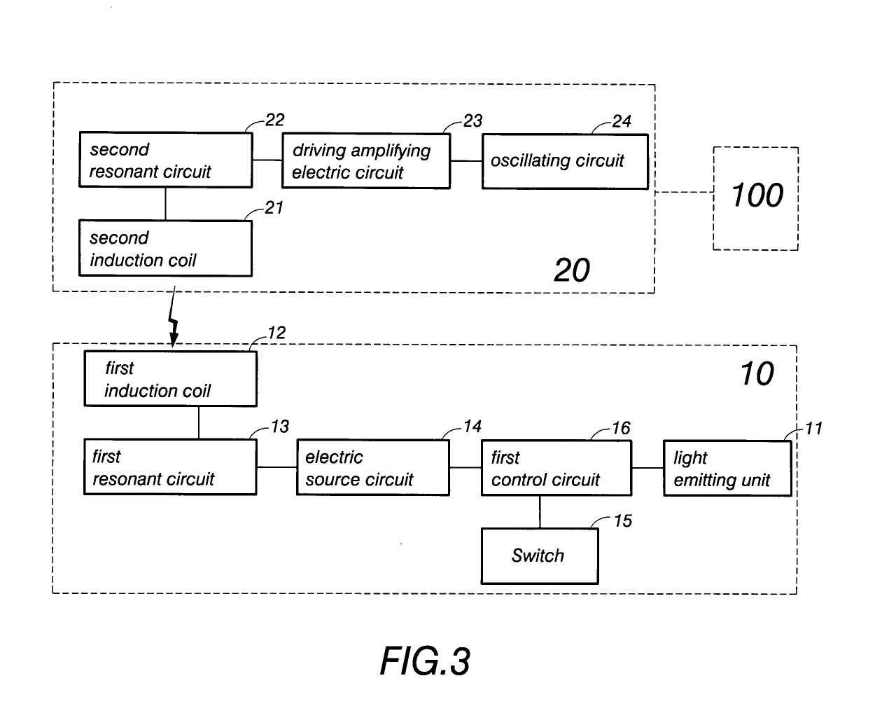

FIG. 3 is a block diagram showing a second embodiment of the present invention, for the purpose that the non-contact light emitting display 10 can obtain electric power by means of wireless radio frequency induction (by the measures of induction using a plane coil without an iron core) when the non-contact light emitting display 10 enters the effective induction scope of the inductor 20, the non-contact light emitting display 10 can further be provided with a first resonant circuit 13 on the basis of the first embodiment, and the inductor 20 can further be provided with a second induction coil 21, a second resonant circuit 22, a driving amplifying electric circuit 23 and an oscillating circuit 24, in order to render the non-contact light emitting display 10 to obtain electric power by means of wireless radio frequency induction; and for the purpose of enduing the non-contact light emitting display 10 with an effect of independent turning on/off, the non-contact light emitting display 10 can further be provided with an electric source circuit 14, a switch 15 and a first control circuit 16 to help performing of turning on/off action of the non-contact light emitting display 10. When in practicing, the switch 15 can be a manual switch, a human body detector, a smoke detector, a temperature detector, a water detector, a light source detector or an infrared beam detector etc.

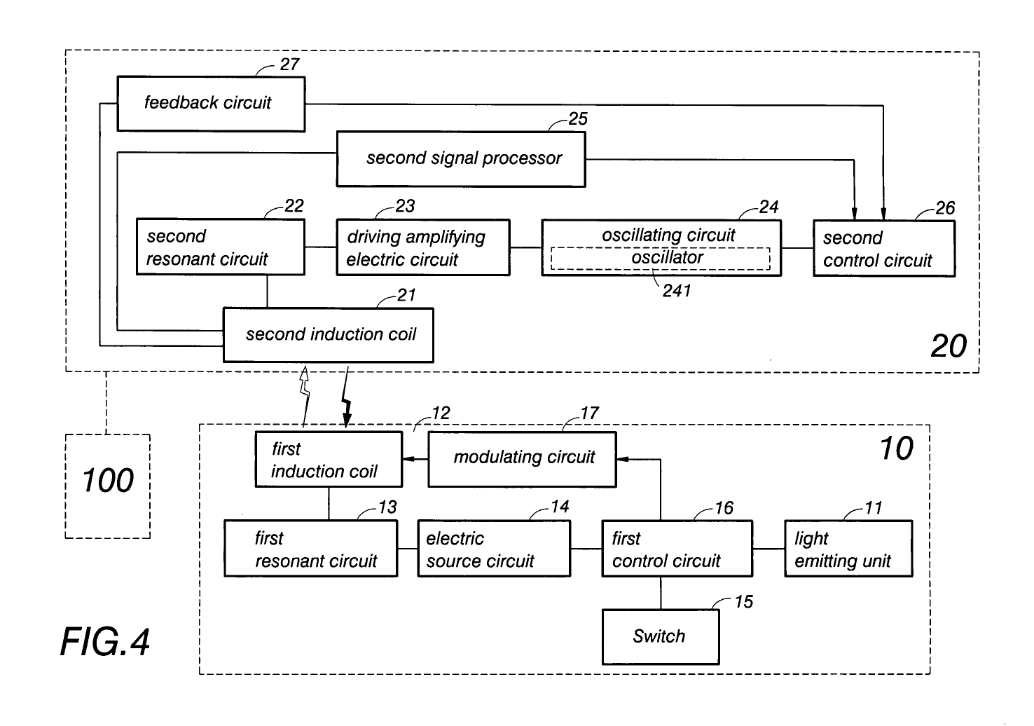

FIG. 4 is a block diagram showing a third embodiment of the present invention, for the purpose of making the non-contact light emitting display 10 provide signals such as related safety detecting signals and control signals for the vehicle 100, the non-contact light emitting display 10 can further be provided therein with a modulating circuit 17 on the basis of the second embodiment, and the inductor 20 is provided therein with a second signal processor 25, a second control circuit 26 and a feedback circuit 27, and the oscillating circuit 24 is provided therein with an oscillator 241 adapted for frequency modulation, in order to help performing signal transmission of the non-contact light emitting display 10 to the vehicle 100.

When the first control circuit 16 of the non-contact light emitting display 10 sends off signals via the modulating circuit 17 and the first induction coil 12, the second induction coil 21 of the inductor 20 receives the signals, the inductor 20 can thus distinguish the state of use of the non-contact light emitting display 10 through the second signal processor 25, the feedback circuit 27 and the second control circuit 26, and the signals are sent to the vehicle 100, thereby the vehicle 100 can do control in corresponding to the signals. For example: if the non-contact light emitting display 10 is a directional signal lamp, and when its light emitting unit 11 is damaged to induce change of load, the inductor 20 can transmit signals to the control system of the vehicle 100, in order to activate the warning mechanism of the vehicle 100 itself to accelerate flashing of the other directional signal lamps.

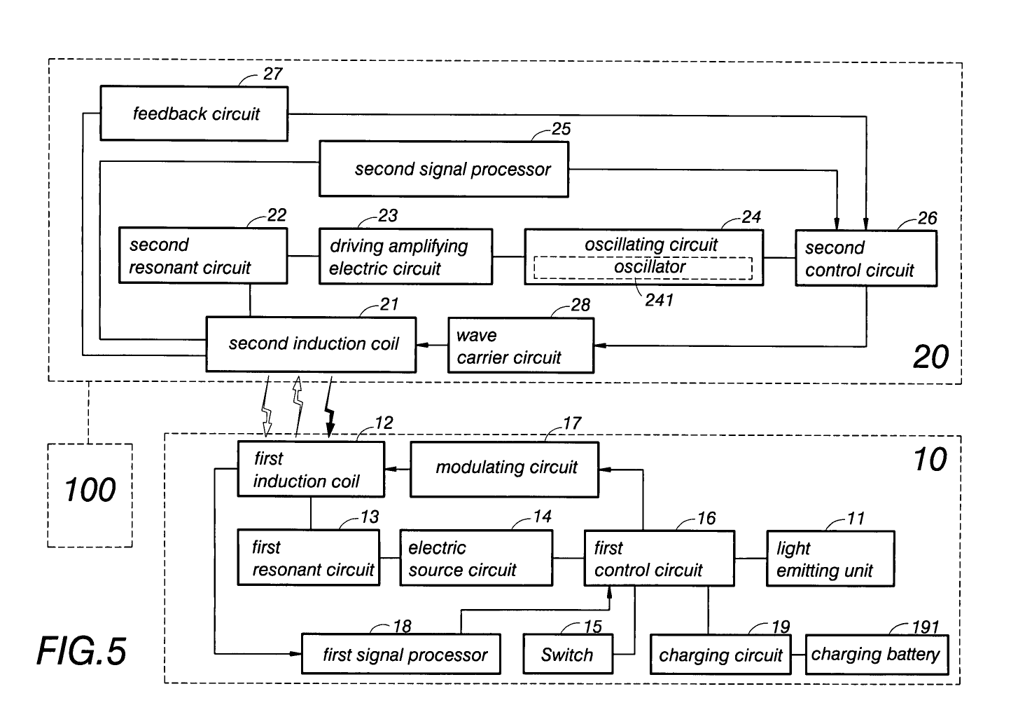

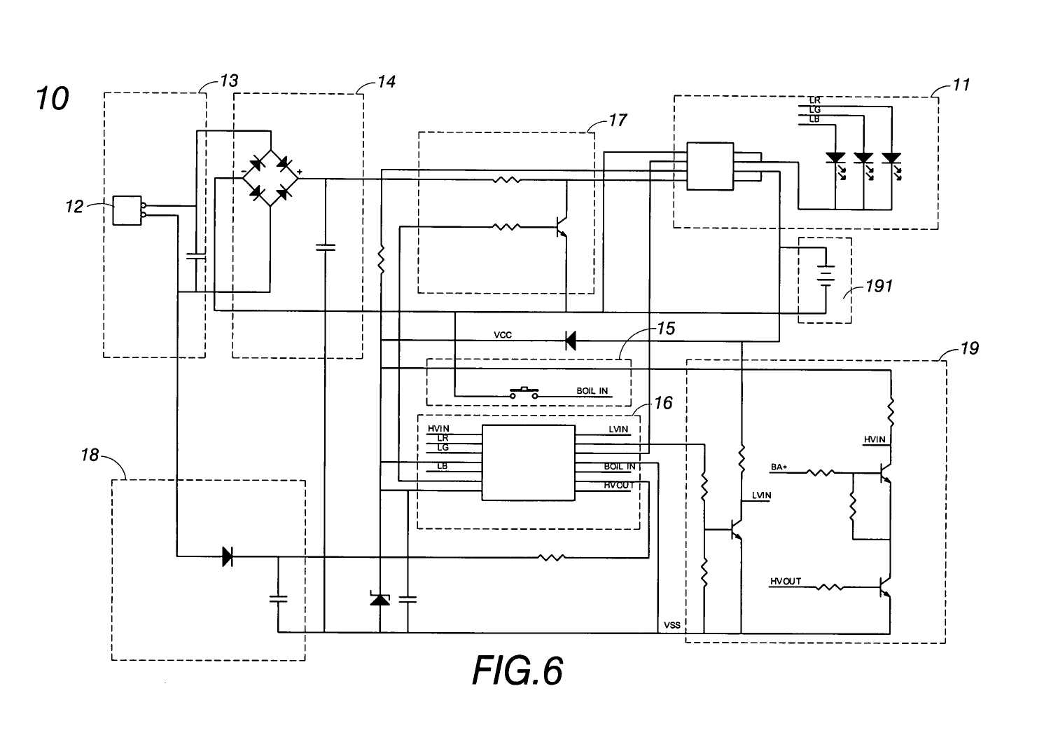

FIGS. 5 and 6 are respectively a block diagram showing a fourth embodiment of the present invention and a circuit diagram showing the allocation of electric circuit of the fourth embodiment; wherein the inductor 20 distinguishes the state of use of the non-contact light emitting display 10, then it can send back some predetermined control signals back to the non-contact light emitting display 10 to make the latter act correspondingly. When in practicing, the non-contact light emitting display 10 can further be provided with a first signal processor 18 on the basis of the third embodiment, and the inductor 20 can further be provided therein with a wave carrier circuit 28, when the inductor 20 generates control signals which are sent off via the wave carrier circuit 28 and the second induction coil 21, the first induction coil 12 in the non-contact light emitting display 10 sends the signals to the first signal processor 18 for processing, and sends to the first control circuit 16 which makes the light emitting unit 11 act correspondingly; for example, when other car lamps of the vehicle 100 have abnormal states, the first control circuit 16 in the non-contact light emitting display 10 can make the light emitting unit 11 flash for warning.

Additionally, for the purpose of making the non-contact light emitting display 10 keep electric power required for operation when it moves away from the effective induction range of the inductor 20, the display 10 can further be provided therein with a charging circuit 19 and a charging battery 191, so that the non-contact light emitting display 10 can operate independently when it moves away from the vehicle. For example: as shown in FIG. 1, when the vehicle 100 is a car, the non-contact light emitting display 10 can be in the form of a movable illuminating lamp, while the vehicle 100 is provided thereon with a fixing seat 101 for insertion connecting an electric source (an electric socket for cigarette igniting) in the car, the fixing seat 101 is provided therein with an inductor 20; when the non-contact light emitting display 10 is fixed in the fixing seat 101, it can be conducted by the inductor 20 to get electric power for illuminating interiorly of the car (for reading for instance), and when the non-contact light emitting display 10 is removed from the fixing seat 101, it can be used as a flashlight.

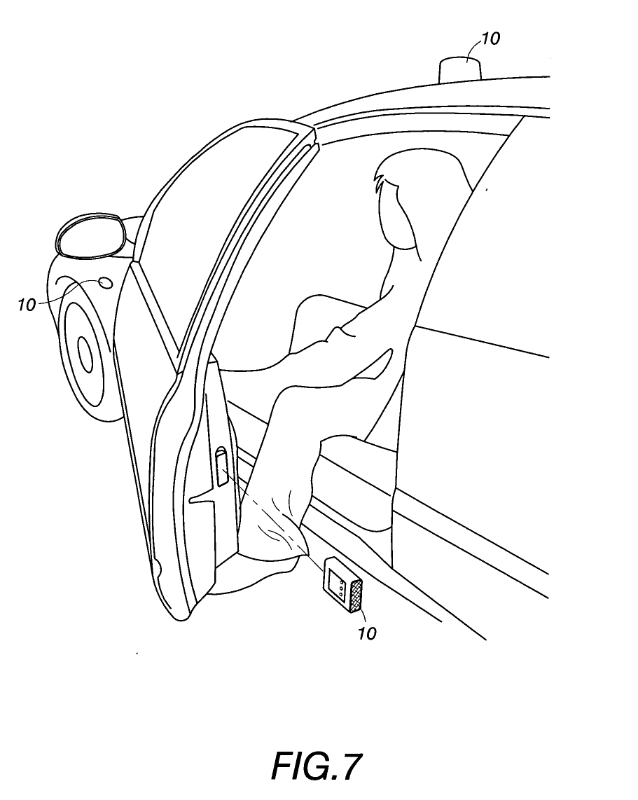

FIG. 7 is a perspective schematic view showing another practice example of the present invention; wherein the non-contact light emitting display 10 can be a directional signal lamp on the outer surface of the car or a warning lamp, or can be mounted interiorly on a side door of the car etc. Particularly when the non-contact light emitting display 10 is mounted interiorly on the side door of the car, it can be removed at any time for using as a flashlight in addition to having the function of warning for safety, and can also be used as an illumination device carried in the car for emergency. Other examples such as being used as a baggage illumination lamp that can be removed to be used as a warning lamp (as is a warning tripod) when a car is out of order, and even can be used as a traffic warning or directing tool at night etc.

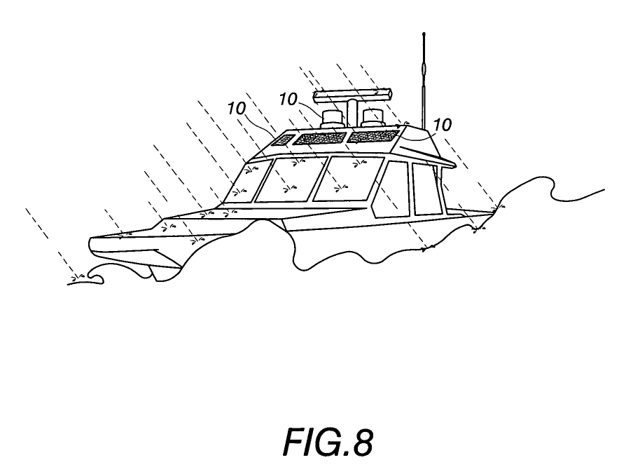

Referring to FIG. 8 which is a perspective schematic view showing one more practice example of the present invention, the non-contact light emitting display 10, in addition to being used on a vehicle on land, can be also used on an aeronautic, a space or a sea vehicle which needs better water proofness and air tightness, such as the ship depicted in the drawing, by virtue that the ship generally is subjected to splashing with sea water and rain, thereby the non-contact light emitting displays of the present invention are quite suitable to be taken for using as lamps on ships, the lamps can save the provision of electric conductors or conducting pins, this renders the lamps on the ships to get even better effect of water tightness, and able to be removed at any time and used as an illumination device carried for emergency.

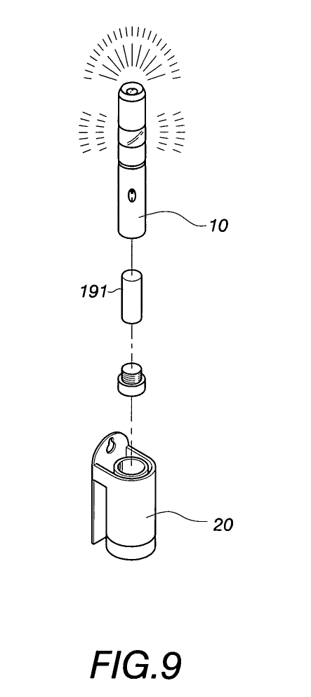

As shown in FIG. 9, the non-contact light emitting display 10 of the present invention can be made in the form of a flashlight, and can further be provided therein with a charging battery 191, and the inductor 20 can be made in the form of a cylinder for receiving a flashlight, when the non-contact light emitting display 10 is received in the inductor 20, the charging battery 191 of the non-contact light emitting display 10 can be charged; additionally, the non-contact light emitting display 10 can further be provided in its middle area with a warning part to flash for giving an effect of warning.

The embodiment stated and depicted above is only for illustrating the present invention, and not for giving any limitation to the scope of the present invention; it will be apparent to those skilled in this art that various equivalent modifications or changes in structure, device and features similar to this invention and without departing from the spirit of this invention shall also fall within the scope of the appended claims.

1. A non-contact light emitting display used for a vehicle, said display at least comprises:
a light emitting unit;
a first induction coil to supply electric power for said light emitting unit; said first induction coil generates electric power by non-contact induction with a second induction coil of an inductor of said vehicle.

2. The non-contact light emitting display used for a vehicle as in claim 1, wherein said display further comprises: a first resonant circuit.

3. The non-contact light emitting display used for a vehicle as in claim 2, wherein said inductor is further provided with a second resonant circuit, a driving amplifying electric circuit and an oscillating circuit.

4. The non-contact light emitting display used for a vehicle as in claim 1, wherein said display further comprises: an electric source circuit, a switch and a first control circuit.

5. The non-contact light emitting display used for a vehicle, as in claim 4, wherein said display further comprises: a modulating circuit.

6. The non-contact light emitting display used for a vehicle as in claim 5, wherein said inductor is further provided with a second signal processor, a second control circuit and a feedback circuit.

7. The non-contact light emitting display used for a vehicle as in claim 6, wherein said inductor is further provided with a wave carrier circuit.

8. The non-contact light emitting display used for a vehicle as in claim 7, wherein said display further comprises: a first signal processor.

9. The non-contact light emitting display used for a vehicle as in claim 4, wherein said switch is a manual switch, a human body detector, a smoke detector, a temperature detector, a water detector, a light source detector or an infrared beam detector.

10. The non-contact light emitting display used for a vehicle as in claim 1, wherein said display further comprises: a charging circuit and a charging battery.
